(19) United States
(12) Patent Application Publication
(10) Pub. No.: US 2006/0085231 A1
(43) Pub. Date: Apr. 20, 2006

(54) Method and system for distribution and payment for pharmaceuticals

(75) Inventor: Harvey Fred Brofman, Holbrook, NY (US)

Correspondence Address: LAW OFFICE OF SANFORD J ASMAN, 570 VININGTON CT, ATLANTA, GA, 30350-5710, US

(73) Assignee: OPUS Health, LLC

(21) Appl. No.: 11/252,042

(22) Filed: Oct. 17, 2005

Related U.S. Application Data
(60) Provisional application No. 60/619,537, filed on Oct. 16, 2004.

(51) Int. Cl. G06Q 40/00

(52) U.S. Cl. 705/4; 705/39

(57) ABSTRACT

The method involves the distribution of cards in connection with a program being administered. The cards are preferably, but not necessarily, in the form of a standard debit card issued through a standard network, such as VISA. In addition to any debit card indicia, the cards have on them the same indicia as a standard health insurance card, although they are not issued by a health insurance provider. When the card is presented to a pharmacy, the health insurance indicia allows the pharmacy to “adjudicate” the card, through the standard network, whereby the program administrator will instantly activate the card, if necessary, and provide value to the card, by funding the debit account associated with the card, whereby the card can be use immediately as a standard debit card in payment for the prescription which was filled. A set of business rules, which can be modified at any time, determines the validity and value of the card each time it is adjudicated.

### CROSS-REFERENCE TO RELATED APPLICATIONS

The present application is a continuation of, is based upon, and claims the priority of provisional patent application Ser. No. 60/619,537 entitled METHOD FOR IMPROVING PHARMACEUTICAL PATIENT THERAPY PERSISTENCE OR COMPLIANCE VIA THE USE OF AN INCENTIVE PROGRAM INCORPORATING MEDIA THAT CAN BE FUNDED WITH MONETARY VALUE TO THE CONSUMER which was filed on Oct. 16, 2004.

### BACKGROUND OF THE INVENTION

The present invention relates to a method and system for distribution of, and payment for, pharmaceutical products. In particular, the invention relates to a method and system which improves pharmaceutical patient therapy persistence and compliance via the use of an incentive program which incorporates media, such as a debit card, which can be funded with monetary value for immediate use by a consumer.

Heretofore, various methods have been used by pharmaceutical companies to provide incentives to physicians and patients to utilize their drugs. A major problem with the methods previously used was that they were expensive to implement, unreliable, and difficult to track. For example, a widespread method, used for many years involved drug company personnel who made personal calls on physicians to supply them with product samples, with the expectation that the product samples would be distributed by the physicians to their patients. As such, this method is highly labor intensive, and very difficult to track.

Further, it has been estimated that many physicians distribute the samples in ways other than the way the drug companies would prefer them to be distributed, with approximately fifty percent of the samples being given by the physicians to patients who have no medical insurance, formulary issues (e.g., high co-pays), and the remaining fifty percent being distributed, about equally, between personal use in the physicians' offices and to those patients to whom the drug companies actually intended the samples to have been distributed. Thus, at any given time it is at best presumed that only about one-fourth of the drug samples which are provided to physicians are actually distributed in the manner in which the pharmaceutical companies would like them to be distributed.

Another widespread problem with drug distribution has been tracking and rewarding patient compliance. One method heretofore used involved the distribution of rebate coupons which patients had to send to rebate fulfillment centers after having filled a prescription. As rebate programs require that the consumer first pay for a product, then properly prepare and submit the rebate coupon, together with required receipts and documentation, such programs are also difficult to track, and they are not well received by consumers. Since the data collected both on and via this process is very limited, the pharmaceutical company's ability to measure the effectiveness of the incentive program is, necessarily, limited as well. Additionally, the inconvenience of mail-in coupons and consumer resistance to such programs has been shown to reduce the effectiveness of this type of incentive.

Traditional discount or rebate programs have been used in the pharmaceutical arena for various levels of rewarding patients for some time. This has also been done through consumer rebate coupons that are typically mailed in for a rebate or presented at the cash register for a discount in the consumer's local pharmacy. Some programs wrote a check back as a rebate for participation in a program that could only be used at the specific pharmacy for the next prescription being dispensed. All of these programs have met with various levels of success and all suffer from the same major problems, namely, very high administration costs, and inadequate reporting methods with respect to the effectiveness of the program in increasing patient compliance. Additionally, since these programs had to be kept administratively simple they therefore had to either be “cash only” or “insurance only” programs. This inflexibility reduced the practicality of these programs.

Another approach which has been taken, but which also has problems, involves the distribution of funded debit cards for use by patients to obtain drugs at a pharmacy. Problems with this approach have been that the cards which were distributed have had to have some initial funding associated with them at the time they are distributed. While various arrangements have been made between the pharmaceutical companies and the banking networks (e.g., STAR or MAESTRO) to minimize the amount a card would have to be pre-funded when it is distributed, the need for any such funding acts as an impediment to the use of such techniques. Further, the distribution techniques allowed a patient to use the funding on the card by calling an “800” number and stating that he was about to use the card for the intended purpose, i.e., to purchase the drug which his physician had prescribed. Nevertheless, it has been found that because the cards used in such programs are pre-funded, patients have used them to make purchases other than those intended by the pharmaceutical company which distributed and funded them. Since unused pre-funded cards continue to hold the money, their value is lost to the sponsor.

Ideally, a system for encouraging patient compliance, while facilitating data collection would not involve the consumer having to take extraordinary steps in filling prescriptions, nor would such an ideal system significantly vary the traditional roles of the physician, the drug company, or the pharmacy.

Further, such a system would allow funding of a distributed debit card only when a patient was in strict compliance with the “rules” of the sponsor which distributed the cards. In addition, it would be desirable to have a system in which the patient had to take no action to have the card funded if he was compliant with the rules of the sponsor which provided the card, and in which the sponsor providing the card could obtain quantifiable data regarding the use of each card.

### SUMMARY OF THE INVENTION

The present invention is a system and method which provides a funding mechanism whereby a physician can write a prescription to a patient, and provide the patient with a media card which initially has no cash value. Alternatively, patients can “opt-in” to a program which will then send the patient a media card. The media card can be instantly funded at the time the patient seeks to use the media to pay for the prescription.

The present invention also provides a system in which the entity providing the funding does not have to “pre-fund” the media, yet the system is extremely flexible, so that the entity which funds the media can do so based on business rules which can evolve over time, so as to provide financial incentives to patients to obtain both an initial prescription as well as follow-up prescriptions, with the actual incentive amount being determined at the point of sale, also, in accordance with the business rules.

Further, as the business rules do not have to be tied to a particular drug, it is possible for the entity which provides the media to allow its use with respect to a plurality of products, or even to add benefits which relate to products which were not part of the program when the media was first distributed (including newly offered drugs). In addition, the business rules can be developed to encourage the purchase of multiple products (e.g., insulin and syringes) at the same time.

In accordance with the method of the present invention a media card, preferably in the form of a plastic card, similar to a healthcare benefits card or debit/credit card, is distributed to a patient who brings it to his pharmacy where he gives it to the pharmacist in conjunction with a prescription, together with any other prescription insurance benefit information which the patient has.

In accordance with the invention, the media is distributed via participating medical doctors or prescribers, pharmacies, “direct to consumer” (e.g., a magazine insert), or so called “opt-in programs” where the patient enrolls, e.g., via mail, a toll free number or the Internet. The media is preferably encoded with information that identifies a particular pharmaceutical compliance program (similar to that used with prescription benefit cards). As part of the filling process at the pharmacy, the pharmacy validates the media (e.g., the pharmacist adjudicates the prescription based on the information on the card) which has the effect of confirming the benefits provided by the card, possibly activating the card (if it had not previously been used), and “funding” the account associated with the card with value to be used in connection with the purchase of a qualifying prescription). All of the foregoing is done via the typical prescription benefit adjudication process currently in widespread industry use. The pharmacy then dispenses the prescribed medication for the patient.

The prescription drugs obtained by using the media card can be used either to replace traditional sample product, thereby eliminating the distribution of physical drug samples through physicians, and replacing that process with providing sample product directly from pharmacies, or enhancing the sampling process with fewer physical samples while providing the media card in a “starter” or “sample” kit. Alternatively, without varying the process being used, the present invention can also be used as part of a compliance program, or even to address prescription payment needs, such as the funding of federal drug programs or the payment for prescription drugs through flexible spending accounts.

Irrespective of the manner in which the present invention is used, the adjudicated process data is provided to the administrator of the program, and it can be used to measure the success of a sampling program, the persistence of the patient on therapy, or anything else which has been designed into a particular program based on business rules. As the data can be used to measure the effectiveness of the process, it can be used for marketing, reporting, pharmaceutical representative incentives, better targeting for the process and other measurements which the sponsor (typically, but not always, a pharmaceutical company) finds useful.

The present invention relates generally to the tracking and distribution of rewards for pharmaceutical product persistence by patients and more particularly to an improved method of dispensing, tracking, and managing persistence programs by proactively collecting data and providing patients with incentives for their behavior in a real-time environment using pharmacies and the adjudication process. This allows integration into existing (or the creation of new) loyalty programs through the advantages provided by the compliance and persistence tracking capabilities made available by the present invention.

In view of the foregoing benefits which the system of the present invention is able to provide, it can also be used in areas where no acceptable alternative presently exists. By way of example, the media cards used in connection with the present invention could be distributed as unfunded debit cards which could then be used in connection with federal drug assistance plans, or as a way of funding prescription purchases through flexible spending accounts. Also, use of the cards in accordance with the present invention overcomes limitation in areas in which physical sampling is prohibited or in which controlled substances are the subject of the program.

### BRIEF DESCRIPTION OF THE DRAWING

In the Drawing:

FIG. 1 is a front view of the compliance media used in the preferred embodiment of the invention;

FIG. 2 is a rear view of the compliance media used in the preferred embodiment of the invention;

FIG. 3 is a flow chart illustrating the manner in which the compliance cards are created and distributed;

FIG. 4 is a flow chart illustrating the manner in which the compliance card and method of the present invention are carried out from the perspective of the patient and pharmacist; and

FIG. 5 is a flow chart illustrating the manner in which the compliance program administrator handles a “pseudo-adjudication” process in accordance with the present invention.

### DETAILED DESCRIPTION OF AN EXEMPLARY EMBODIMENT OF THE INVENTION

The present invention is a method or process which provides patients with access to benefits associated with pharmaceutical products. Specifically, the present invention allows patients to receive financial benefits which are highly adaptable by the benefit provider and which are capable of extreme customization while providing the sponsor (or “benefactor”) of such benefits with an ability, heretofore unavailable in the prior art, to create and modify business rules associated with such benefits. The present invention provides a means by which business rules, once created, can evolve during a particular promotion, or be replaced with entirely new rules relating, even, to different drugs, dosages, physician, pharmacy used, or anything else that the program administrator or the sponsor desire. As will be understood a change in a business rule, once made, becomes effective immediately at the point of sale.

As will be seen, the method of the present invention can be adapted for use in a drug sample program, or in a compliance benefit program, or in virtually any other type of program in which a set of appropriate business rules can be developed to provide a financial benefit to a patient filling a prescription.

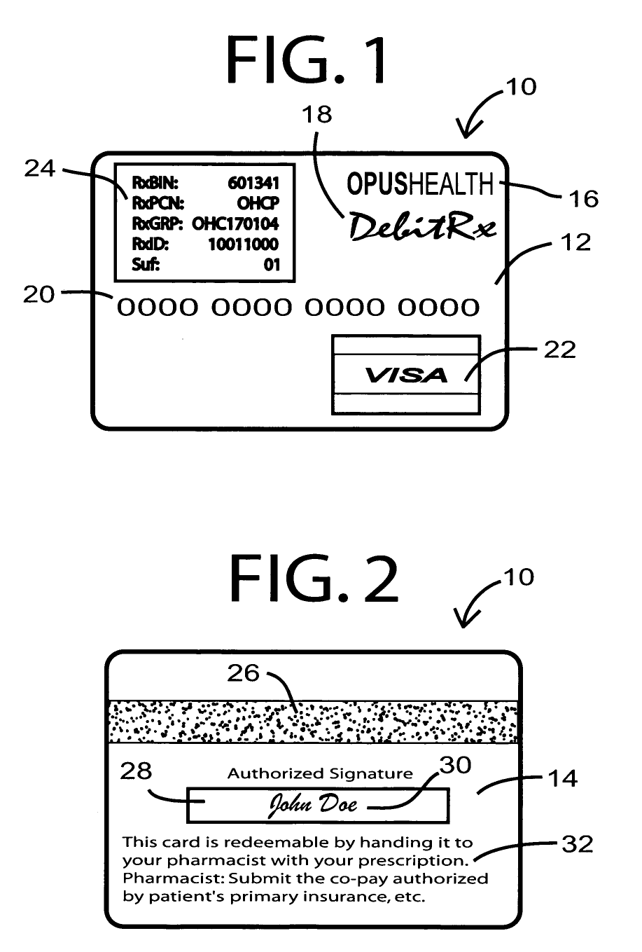

As illustrated in FIGS. 1 and 2, the invention makes use of a card 10, referred to herein as either a “card” or “media”. The card 10 has the appearance of a standard debit card having a front 12 and a back 14 in the preferred embodiment of the invention.

In accordance with standard industry practice, the card 10 used in the preferred embodiment is constructed of a plastic material, and the front 12 includes standard indicia such as the name of the program provider 16, the trademark 18 associated with the media 10, a card identification number 20, the name or logo 22 of the entity through which the compliance media is networked, and any other desired information (e.g., a bank name and logo, validity dates or a “valid thru” date, the name of the card holder, a security code, e.g., CVV or CVV2, a security hologram, etc.). In addition, as will be explained hereinafter, the card 10 is intended to act like a health insurance card, so it preferably also contains a healthcare information area 24 in which information of the type required on a standard health insurance card is located. Typically, such information includes a Bank Identification Number, RxBIN; a Processor Control Number, RxPCN; a Group ID, RxGRP; a member ID, RxID; and a Suffix, Suf. As will be understood by those familiar with the adjudication process in which a pharmacy adjudicates a prescription drug plan at the time a prescription is filled, the foregoing information, located in the healthcare information area 24 is the very same type of information which is required to be present on a health insurance card of the type used with standard health insurance companies. It is this information which is used then a pharmacy adjudicates a health insurance prescription claim when a prescription is filled.

The rear 12 of the card 10 typically includes a magnetic bar stripe 26 and a signature area 28 which is adapted to allow the card holder (i.e., the patient) to write his signature 30 thereon in ink. The rear 12 may also hold other desired information (e.g., telephone numbers, one or more network names, a network name or logo, a bank name and logo, writings indicating that the card is not valid until signed, etc.). There is generally, also a section which contains instructional text 32 advising the patient to present the card 10 to the pharmacist with his prescription. The instructional text 32 preferably also provides the pharmacist with instructions to submit the co-pay authorized by the patient's primary insurance company as a secondary transaction (or, alternatively, to submit the claim at the usual and customary rates, in the case of an uninsured patient) to the program provider 16 named on the front 12 of the card 10. The instructional text 32 will typically also inform the pharmacy that it will be paid a transaction fee for processing the claim, in addition to the fee for drug payment.

As described above, the card 10 which is used in the present invention is, in all relevant aspects, identical to a standard debit card, of the type issued by a bank, and used through one of the standard networks, such as Visa, MasterCard, Diners Club, American Express, etc. However, unlike standard debit cards heretofore known and used, the card 10 of preferred embodiment of the present invention is issued to the card holder with no cash value at the time of its issuance, and further, at the time of issuance the card 10 is inert, in that it has not been activated. Instead of having a present cash value, the value associated with card 10 is created in an “as needed”, on demand basis, as will be described below.

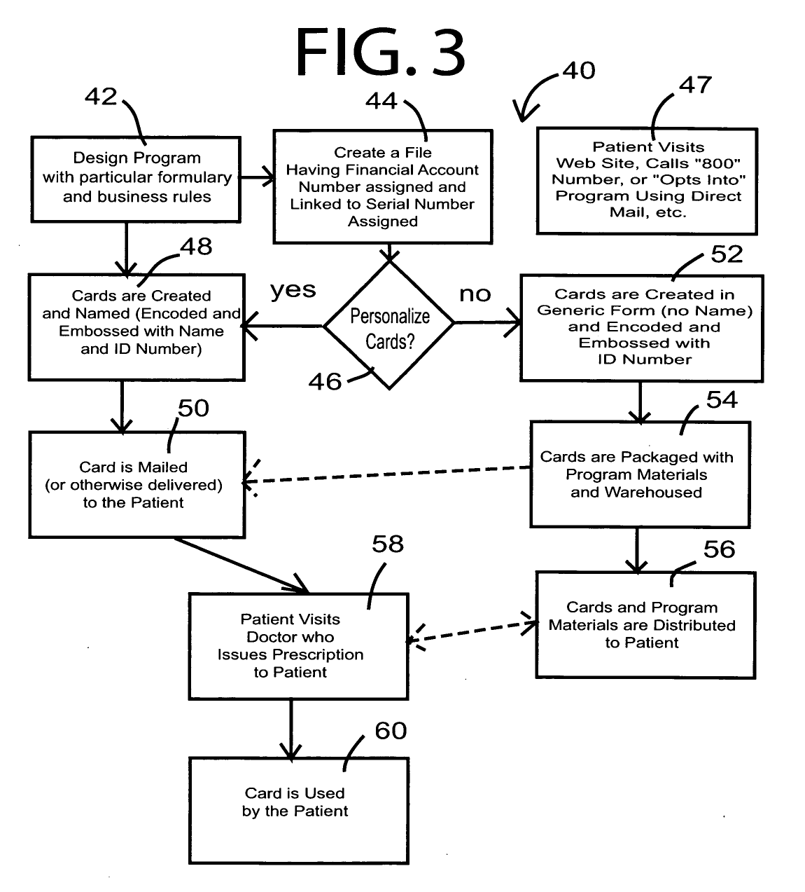

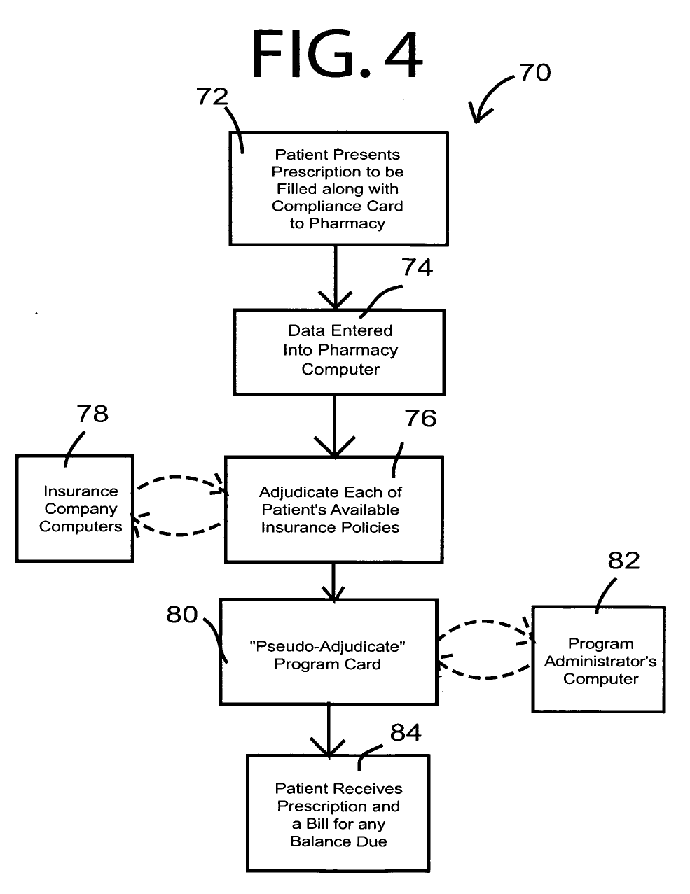

With reference to FIG. 3, the method of the present invention, which uses the card 10, is illustrated in flow chart 40. In accordance with the invention, the method requires several steps. The first step, shown at 42, is to design a “program” having a specific formulary and set of business rules which are to be applied to a particular incentive. As will be explained hereinafter, the method of the present invention allows the set of business rules to be varied, even after a program has begun.

Once a program has been designed, a file is created, as shown at step 44. Typically, the file is created in a computerized database, in which each card is assigned both a card ID (as shown at 20 in FIG. 1) and a serial number to be associated with the particular card 10 in order to link that card 10 to a patient and program.

Before cards are actually produced a determination is made, at step 46, as to whether or not the cards are to be personalized with patients' names. This determination 46 is made based upon the definition of the particular program which was established at step 42. If cards are to be personalized, then it is necessary, of course to have a data table which includes the names, addresses, and other information associated with the patients for whom the cards are being prepared. This patient data can be obtained in a variety of ways. By way of example, the step illustrated at 47 is intended to show some, but not necessarily all, of the ways in which patient data can be obtained. In particular, patients may be encouraged through media advertising (e.g., radio or television commercials, newspaper and magazine ads, direct mail, Internet ads, etc.) to “visit” an Internet web site, or to call an “800” number, or to mail in an information card, with the information thus obtained being entered into a table in a computerized database. Alternatively, it may be possible in some instances to otherwise obtain, or use, data from a pre-existing database, as the specific manner of obtaining the patient's name and address is not critical to the present invention.

Assuming that a decision to personalize the cards has been made at step 46, then cards having patient names encoded and embossed, along with the card ID, etc. are created, at step 48, with the patient name information from the patient data table described above. The completed card is then mailed, or otherwise delivered, to the patient, as illustrated at step 50.

In the event that a particular program calls for some or all of the cards to be delivered to patients whose names are not known at the time of card creation, then a decision to create non-personalized cards will be made at step 46, and cards will be created in generic form (i.e., without a patient name), as illustrated at step 52. These generic cards are preferably then packaged and warehoused (along with any desired program materials) for distribution to patients, as shown at step 54. The generic cards can then be mailed to patients who have responded to advertising, as shown at step 50, or they can be distributed in bulk to drug company representatives for doctor or pharmacy detailing. Depending upon the particular manner in which a particular program has been designed, any given card (and associated program material) can be individually distributed directly (e.g., by mail) to a patient, or by a doctor or pharmacist, all as illustrated at step 56. Following either step 50 (for personalized cards) or step 56 (for non-personalized cards) a patient will have a card associated with a particular program.

If the patient then visits a doctor (or other prescriber) and is issued a prescription for a pharmaceutical product which is associated with the program, as shown at step 58, the patient will then be in possession of both a card and a prescription, bearing in mind, of course, that it is possible for step 56 to be combined with step 58, in the case in which the prescriber is also the means for delivering the card to the patient. Further, if the means for distributing the cards involves the doctor advising the patient to follow step 48, or if the card delivery means shown at step 56 is actually via distribution at a pharmacy, those familiar with the art will recognize the possibility that steps 56 and 58 can occur in reverse order. All that is important is that prior to step 60, at which the patient uses the card at the pharmacy, the patient is in possession of both a card and a prescription.

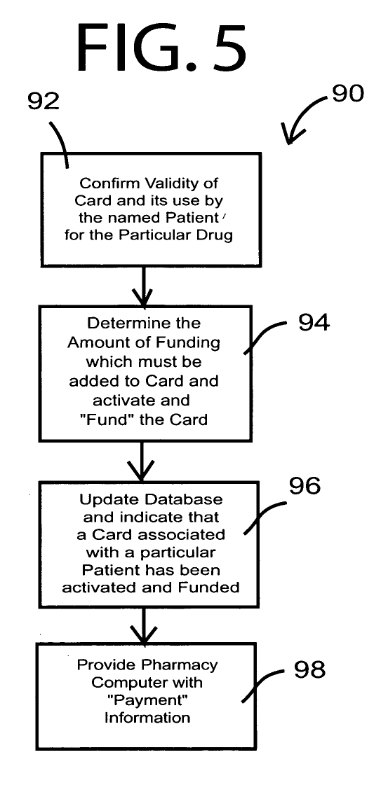

With reference, now, to FIG. 4, the manner in which the card 10 is actually used by the patient is described in detail using the flow chart 70. As shown, at step 72, the first step in the process involves the patient presenting both a prescription and a card 10, along with any other relevant insurance information which he may have, to the pharmacist. Alternatively, the patient's insurance information may already be in the pharmacy's database, in which case the patient will merely identify himself to the pharmacist, and present the card 10 and prescription to be filled. In either case, the patient's identification, prescription, and card information, are all entered into the pharmacy computer at step 74.

As is understood by those skilled in the art, modern pharmacies have computer equipment and software which allow them to be networked to the backend computers of insurance companies. As will be understood by those skilled in the art, the networking of pharmacy computers to insurance company or prescription benefit managers' computers conducted over one or more of the networks which provide such service, which currently include WebMD, eRx Networks, and NDC. Thus, it has been standard practice for some time for pharmacy personnel to adjudicate prescriptions by entering the patient insurance identification information, doctor information, and the specific prescription into their computer system, which then communicates over a network to the insurance company computer. The result of that communication is that an authorization is provided by the insurance company's computer to the pharmacy confirming the validity of patient's coverage and authorizing a particular payment to the pharmacy based on such coverage. In that it is not unusual for a patient to have multiple coverage (e.g., where both husband and wife have separate medical insurance provided, for example, by their respective employers), the pharmacy computers are able to communicate with multiple insurance company computers to obtain verification and funding from the primary company, and then the secondary company, etc., ultimately exhausting the available coverage for the particular prescription and leaving a balance which is then due from the patient as his “co-pay”. Depending on the drug(s) prescribed, and the particular insurance available to the patient, the balance due from a particular patient to fill a particular prescription will (typically) be diminished as each insurance company fulfills its contractual obligation. Thus, a patient who has no insurance, will be asked to pay the amount the pharmacy charges for a particular drug, while a patient who has a single insurance plan will generally be asked to make a co-payment based upon the amount the pharmacy has contractually agreed to accept from patients who are insured by that particular insurance plan. As will be understood by those skilled in the art, a patient who is a “member” of a particular insurance plan may well be charged less, at the outset, for a particular drug, with such lesser payment being determined by contract between the insurance company and the pharmacy. Accordingly, following each adjudication, the balance of the co-payment amount due from the patient will be reduced. Thus, for a patient who has coverage through multiple insurance plans, the pharmacy computer will communicate with each plan in order, based upon that patient's primary plan, his secondary plan, etc. These steps, which may involve multiple insurance plans, are all illustrated at step 76, which step is repeated with the appropriate insurance company computers 78 based upon the number of plans available to the particular patient.

The foregoing description explains the way prescription adjudication has heretofore been accomplished. With continued reference to FIG. 4, the new step which is added by the method of the present invention is illustrated at step 80, in which the pharmacy computer handles the program card information. In particular, the system and method of the present invention have been designed so that the card 10 is treated like an insurance prescription card in that it contains the required data, shown at 24 in FIG. 1. In particular, as far as the pharmacy computer is aware, the information 24 on the card 10 is treated as yet another insurance card. Accordingly, from the perspective of the pharmacy computer system, step 80, is simply handled as one more adjudication in the process, except that this step 80 is actually a “pseudo-adjudication” is handled with the program administrator's computer 82, rather than with one of the insurance company computers 78. Of course, in the case of a “cash” customer, i.e., one who has no insurance, the present invention is still usable in that the “pseudo-adjudication” step 80 can take place with the program represented by the card 10 being treated as the patient's primary coverage, all without any modification to the existing adjudication process. After the “pseudo-adjudication” step 80 by the program administrator, which further credits the patient's account with the pharmacy, the pharmacist will dispense the prescription and present it to the patient with a bill for any remaining payment which might be due from the patient, e.g., for other prescriptions which the patient presented at step 72 which were not covered by the card 10, for any remaining co-pay, etc., as illustrated at 84. Notably, the “pseudo-adjudication” step can include the ability to send a message to the pharmacy, as explained below.

With reference now to FIG. 5, the steps which take place at the compliance program administrator's computer during the “pseudo-adjudication” step 80 (See, FIG. 4) are illustrated in flow chart 90. Upon receipt of data transmitted from a pharmacy, the program administrator's system will first confirm the validity of the card, and its use by the named patient for the particular drug, as shown at step 92. Accordingly, the present invention can include, as part of this step 92, confirmation that the particular patient who presented the card to the pharmacy is the same person to whom a personalized card was issued, if the program business rules require such confirmation. In addition, this step is used to confirm that the particular prescription is one which is within the program to which the particular card which was presented, is eligible to participate. Thus, if a particular program has been established by a pharmaceutical company to encourage doctors to prescribe a particular branded drug from that company, and the patient presents a prescription for (or the pharmacist attempts to fill the prescription with) a generic drug, approval for funding will be denied.

Next, the amount of funding, which is required to pay all, or any portion of, any existing balance due after the prior insurance company benefits have been determined at step 76 (See, FIG. 4) is determined, and the card is then activated, if it has never before been used. The card is then instantly “funded” with a value corresponding to that amount, with the instant funding being accomplished by communication between the program administrator's computer 82 and the computer of the financial institution which issued the card or whose name appears on the card. In the case of an affinity card points, rather than cash, may be added as described below. Thus, the actual activation and funding of the card takes place as part of the “pseudo-adjudication” process step 80, shown in FIG. 4. In that the method of the present invention acts the same as any other adjudication step as far as the pharmacy's computer and the network to which it is connected are concerned, use of the present invention requires no modification to the pharmacy systems which are already in place.

Next, at step 96, the program administrator's database is updated to show the data which is being collected for a particular program (e.g., patient serial number, drug dispensed, pharmacy, doctor id, amount funded, etc.), and the balance due for funding future cards presented for the relevant program is updated to reflect the funding made in the current transaction. Finally, the pharmacy computer is updated with payment information, as shown in step 98, which may, additionally contain a relevant text message generated by the program administrator's computer 82, e.g., advising the pharmacy that it should submit a claim to the primary payor, if any, first; or, the message could explain why the business rules then in effect declined a payment.

As will be understood by those familiar with the adjudication process, as used heretofore, the use of the present system and method, does not require any modification to the pharmacy computer, to its software, or to the existing networks in order to accommodate the activation and “instant funding” of the card 10 which takes place during the step 94.

At the pharmacy, the pharmacist now uses the newly funded card 10 as a debit card in the normal manner for payment of all or a portion of the bill remaining at step 84 (See, FIG. 4).

In an alternative embodiment, the step 84 of funding can be done by the program administrator in a somewhat different manner, in that the program administrator may simply forward, electronically or otherwise, a payment to the pharmacy in the “funded” amount, whereby the step 98 of providing the pharmacy computer with payment information is accomplished by showing that a lower payment amount (possibly zero) is due from the patient at step 84 (See, FIG. 4).

While the preferred embodiment of the invention has been described, those skilled in the art will recognize that many variations may be made without departing from the spirit or scope of the invention as claimed. By way of example, the description above indicated that the patient will present the prescription to be filled to the pharmacist (See, FIG. 4, at step 72). Actually, the specific method of by which the prescription gets to the pharmacy is immaterial with respect to the invention. Other methods, such as telephone, fax, or electronic transmission are equally suitable for transmitting the prescription to the pharmacy. Once the pharmaceutical product has been prescribed, the patient then proceeds to the participating pharmacy where the prescription for the pharmaceutical product is filled.

In that the transactions are recorded at the program administrator's computer using the industry standard adjudication process, it is possible to periodically compensate participating pharmacies for the service performed via a fee to cover the projected transactional costs of the adjudication process. Consequently, text 32 included, e.g., on the rear 14 of the card 10 (See, FIG. 1), advises the pharmacist that they will be compensated.

For the reasons expressed above, the card 10 appears to both the consumer and the pharmacy to be the same as any conventional debit or credit card (or, alternatively, as an affinity card) both in appearance, and in the manner in which it is used. Rewards can therefore be used for any store purchase on that occasion or another, in that the card can be funded in an amount greater than the amount due for payment of the prescription. When used as described above, the mere act of using the card 10 enhances the ability to track product movement, patient compliance, or other data associated with the doctor, the drug, the pharmacy, or the patient, all in an automated process which requires no additional effort by anyone involved in prescribing the drug or filling the prescription, and the process requires no unique action on the part of the patient, as did the rebate programs previously used. At the same time, the process is easily administered without complicated transactions or paperwork since it uses business communication methodologies currently in place in the industry.

Further, the step 94 of determining the amount of funding (shown in FIG. 5) can include a series of business rules unique to any given program and, if desired by the sponsor of the program, the rules can be modified and evolve over the duration of the program.

By way of example, specific business rules can be developed so as to provide variable discounts, thus allowing for multiple incentive program designs and creative incentive programs. Alternatively, the business rules can be configured to incorporate the free prescription concept, or a discount coupon concept into the overall incentive program design.

When the card 10 is used to enhance and track compliance, the business rules can be such as to provide a variable incentive based upon such things as the number of days since the card was last used to fill a prescription for a given drug. Alternatively, the business rules can be developed to provide an incentive based upon the purchase of a particular branded drug at a particular pharmacy chain. Essentially, any data associated with the patient, the doctor, the drug, the pharmacy, the dosage, or any other data available to the program administrator can be used in a set of business rules to determine the amount of funding to be awarded at step 94.

As will be understood by those skilled in the art, the use of the present invention in a compliance program improves compliance by ensuring that the desired patient behavior is always achieved prior to the reward of funding being issued.

As explained above, this design also allows the business rules for the incentives to be customized to the individual patient level, whereas traditionally, these programs were limited to a more general, non-specific scope.

In addition the program can be configured with numerous program reward structures by simply modifying the business rules associated with the card, even to the extent of it being possible to create an entirely new program, all without the need to distribute a new card to a card holder.

In that the present invention does not require card activation by a patient, doctor, or pharmacy, neither PIN codes nor prior funding are required, thereby enabling large scale card distribution without burdening the health care system outside the scope of treatment.

In that the “pseudo-adjudication” step enables program performance tracking as all data is captured electronically for each prescription that is filled, the invention relieves all of the issues surrounding the various program types and their goals into a uniform program that can be administered without the complicated rules which confuse patients, doctors, and pharmacists, eliminating the failure points present in prior rebate, pre-funded card, sample distribution, coupon, or other systems known in the prior art.

When the card is funded and used as a debit card to pay the pharmacy for the drug, the debit card aspect of the card is integrated into the natural process for filling, and paying for, a prescription, without any opportunity to inadvertently provide the program incentive until the behavior is performed (e.g., the prescription is actually filled), because the card is funded at the point of sale. Funding (or activation and funding, for the first use) at the point of sale means that the card does not have to be pre-loaded or auto funded, thereby minimizing program inception expenses to the sponsor.

As the business rules can be changed at any time, the same card may be re-used for the same program or additional programs as it is presented to the pharmacy each time a prescription is filled.

The method can be used in conjunction with any healthcare insurance program, as it acts just like their programs act.

Rewards can be varied based on predetermined business rules (program customization is “built in” at program inception).

One card can be used for multiple brands, each brand can have a unique reward structure.

While the description of the preferred embodiment indicated that the financial benefit provided to the cardholder would be in the form of a cash benefit, it should be understood that a retailer which has an affinity program (e.g., a pharmacy chain, a supermarket chain, etc.) can use the method of the present invention to provide a financial benefit to the cardholder in the form of points, rather than cash. In such case, the “pseudo-adjudication” step will be used by the program administrator to communicate the number of points, rather than a cash amount, to be added to the cardholder's affinity card.

I claim:

1. A method for providing a financial benefit to a patient filling a prescription comprising:
(a) creating a benefit card which includes information of the type required for adjudication of a health insurance card, said step being accomplished by a program administrator other than a health insurance provider;
(b) creating a set of business rules, said business rules determining the validity and value of said card when said card is presented at a pharmacy in connection with the filling of a prescription;
(c) providing said benefit card to said patient,
(d) said patient presenting said card at a pharmacy when filling a prescription;
(e) said pharmacy “pseudo-adjudicating” said card after said pharmacy has first adjudicated all health insurance cards available to said patient, whereby said program administrator provides a financial benefit to said patient for use at said pharmacy.

2. The method of claim 1 wherein said step of creating a set of business rules is accomplished prior to said step of said patient presenting said card at a pharmacy.

3. The method of claim 2 further comprising the step of modifying said business rules at any time after said step of creating a benefit card.

4. The method of claim 1 further comprising the step of adding bank network data to said card prior to said step of providing said card to said patient, whereby said card will have all of the characteristics of a debit card.

5. The method of claim 1 wherein said step of “pseudo-adjudicating” includes confirming that the card is valid for use by said patient.

6. The method of claim 1 wherein said step of “pseudo-adjudicating” includes confirming that the card is valid for use in connection with the prescription being filled.

7. The method of claim 1 wherein said step of “pseudo-adjudicating” includes determining the financial benefit of said card based on the then existing business rules associated with said card.

8. The method of claim 1 wherein said step of “pseudo-adjudicating” includes sending a message from the program administrator's computer to the pharmacy.

9. The method of claim 4 wherein said step of “pseudo-adjudicating” includes activating said card if it is valid and it has never before been activated.

10. The method of claim 9 wherein said step of “pseudo-adjudicating” includes determining the financial value to be added to said card based on the then existing business rules associated with said card and then adding said value to a debit account associated with said card, whereby said card can immediately be used as a debit card to pay said pharmacy for at least a portion of the fee for said prescription.

11. The method of claim 1 wherein said step of “pseudo-adjudicating” includes updating a database maintained by said program administrator.
